(19) United States
(12) Patent Application Publication
(10) Pub. No.: US 2017/0199943 A1
(43) Pub. Date: Jul. 13, 2017

(54) USER INTERFACE FOR MULTIVARIATE SEARCHING

(71) Applicant: Veritone, Inc., Newport Beach, CA (US)

(72) Inventors: Chad Steelberg, Newport Beach, CA (US); Nima Jalali, Newport Beach, CA (US); James Bailey, Newport Beach, CA (US); Blythe Reyes, Newport Beach, CA (US); James Williams, Newport Beach, CA (US); Eileen Kim, Newport Beach, CA (US); Ryan Stinson, Newport Beach, CA (US)

(21) Appl. No.: 15/405,091

(22) Filed: Jan. 12, 2017

Related U.S. Application Data
(60) Provisional application No. 62/277,944, filed on Jan. 12, 2016.

(51) Int. Cl. G06F 17/30

(52) U.S. Cl. CPC G06F 17/30991; G06F 17/30985; G06F 17/30867; G06F 3/0482

(57) ABSTRACT

A method for providing a user interface for multivariate searching is provided. The method comprises displaying, by a computing device, the user interface having an input portion and a search type selection portion which may have two or more search type objects. Each object corresponds to a different type of search to be performed, which may be represented by an icon indicating the type of search to be performed. The method further comprises: receiving, by the computing device, a first input string in the input portion and a first selection of one of the two or more search type objects; associating a first search type on the first input string based on the first selection of one of the search type objects; and displaying the first search type and the first input string on the user interface.

### CROSS-REFERENCE TO RELATED APPLICATION

This application claims priority to U.S. Provisional Application No. 62/277,944, entitled “METHODS, SYSTEMS AND DEVICES FOR COGNITIVE DATA RECOGNITION AND MEDIA PROFILES,” filed Jan. 12, 2016, which application is hereby incorporated in its entirety by reference. This application is related to a co-pending U.S. Non-Provisional application Ser. No. 15/405,172, entitled “METHODS AND SYSTEMS FOR SEARCH ENGINE SELECTION AND OPTIMIZATION,” filed Jan. 12, 2017, which is assigned to the same ASSIGNEE as the present application and is hereby expressly incorporated in its entirety by reference.

### BACKGROUND

Since the advent of the Internet, our society is in an ever-increasing connected world. This connected world has led to a massive amount of multimedia being generated every day. For example, with improved smartphone technology, that allows individuals to personally record live events with ease and simplicity, video and music are constantly being generated. There is also ephemeral media, such as radio broadcasts. Once these media are created, there is no existing technology that indexes all of the content and allows it to be synchronized to an exact time slice within the media, for instance when events happen. Another example is an individual with thousands of personal videos stored on a hard drive, who wishes to find relevant ones with the individual's grandmother and father who may wish to create a montage. Yet another example is an individual who wishes to find the exact times in a popular movie series when a character says “I missed you so much.” Yet another example is an individual who wishes to programmatically audit all recorded phone calls from an organization in order to find a person who is leaking corporate secrets.

These examples underscore how specific content within audio and video media is inherently difficult to access, given the limitations of current technology. There have been solutions that provide limited information around the media, such as a file name or title, timestamps, lengths of media file recordings, and others but none currently analyze and index the data contained within the media (herein referred to as metadata).

A conventional solution is to use dedicated search engines such as Bing, Google, Yahoo!, or IBM Watson. These dedicated search engines are built to perform searches based on a string input, which can work very well for simple searches. However, for more complex multivariable searches, conventional search engines and their UI are not as useful and accurate.

### SUMMARY OF THE INVENTION

As previously stated, conventional search engines such as Bing, Google, Cuil, and Yahoo! employ a simple user interface that only allow users to input query using alphanumeric text. This text-based approach is simplistic, easy to use, but inflexible and does not allow the user to perform a flexible multivariate search. For example, if the user wants to search for videos of Bill Gates speaking about fusion energy, using Bing or Google, the user would have to use a text-based search query such as “Video of Bill Gates Fusion Energy.” This leaves the engine to parse the text into different search variables such as Bill Gates in a video and Bill Gates speaking about fusion energy. Although the Google and Bing engines still work for this type of search, it can be inefficient and inaccurate, especially if the search gets even more complicated. For example, “videos and transcription of Bill Gates speaking renewable energy and with positive sentiments, between 2010-2015”. This type of text input would likely confuse conventional search engines and likely yield inaccurate results. As such what is needed is an intuitive and flexible user interface that enables user to perform a multivariate search.

Accordingly, in some embodiments, a method for providing a user interface for multivariate searching is provided. The method comprises displaying, by a computing device, the user interface having an input portion and a search type selection portion. The input portion may be a text box. The search type selection may have two or more search type objects, each object corresponds to a different type of search to be performed. Each object may be represented by an icon indicating the type of search to be performed. For example, a picture icon may be used to indicate a facial recognition search. A music icon may be used to indicate an audio search. A waveform or group of varying height vertical bars may be used to indicate a transcription search. Additionally, a thumb up and/or thumb down icon may be used to indicate a sentiment search.

The method for providing a user interface for providing multivariate search further comprises: receiving, by the computing device, a first input string in the input portion and a first selection of one of the two or more search type objects; associating a first search type on the first input string based on the first selection of one of the search type objects; and displaying, by the computing device, the first search type and the first input string on the user interface. The first search type and the first input string may be associated by visual grouping and/or displaying them together as a group or pair. The association may involve assigning a search type associated with the selected object to be performed on the first input string. For example, in the case of a picture icon as the selected object, then the search type to be performed on the first input string is a facial recognition search. The first search type and the first input string may be displayed within the input portion. Alternatively, the first search type and the first input string may be displayed outside of the input portion.

The method for providing a user interface for providing multivariate search further comprises receiving, by the computing device, a second input string in the input portion and a second selection of one of the two or more search type objects, wherein the first and second selections are of different objects; associating a second search type on the second input string based on the first selection of one of the search type objects; and displaying, by the computing device, the second search type and the second input string on the user interface. In some embodiments, the second search type and the second input string may be displayed within or inside of the input portion. Alternatively, the second search type and the second input string may be displayed outside of the input portion.

In some embodiments, the search type selection portion is positioned adjacent and to a side of the input portion or it may be positioned outside of the input portion. Each of the input string and search type (or icon) is displayed in the input portion. Alternatively, each of the input string and search type is displayed outside of the input portion. Each of search type and its associated input string may be displayed as a combined item on the user interface, inside the input portion, or outside of the input portion.

Finally, the method for providing a user interface for providing multivariate search further comprises: receiving, at the computing device, a request to perform a query using the received first and second query entries; and sending the first and second query entries and the first and second search types to a remote server.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1A illustrates a prior art search user interface.

FIG. 1B illustrates a prior art search results.

FIGS. 3A, 3B, and 4-6 illustrate exemplary multivariate search user interfaces in accordance with some embodiments of the disclosure.

FIG. 7 illustrates an exemplary process for generating a multivariate search user interface in accordance with some embodiments of the disclosure.

FIGS. 8-9 are process flow charts illustrating processes for selecting search engines in accordance with some embodiments of the disclosure.

FIG. 10 is a block diagram of an exemplary multivariate search system in accordance with some embodiments of the disclosure.

FIG. 11 is a block diagram illustrating an example of a hardware implementation for an apparatus employing a processing system that may exploit the systems and methods of FIGS. 3-10 in accordance with some embodiments of the disclosure.

### DETAILED DESCRIPTION

In the following description, numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

### Overview

As stated above, a typical prior art search user interface is one-dimensional, meaning it provides only one way for the user to input a query without any means for specifying the type of search to be performed on the input. Although a user may provide a long input string such as videos of Bill Gates speaking about green energy, the user may not directly instruct the search engine to perform a facial recognition search for videos of Bill Gates speaking about green energy and showing the transcription. Additionally, a traditional search user interface does not allow a user accurately and efficiently instruct the search engine to perform a search for a video, an audio, and/or keyword based on sentiment. Again, the user may enter an input string such as “audio about John McCain with a positive opinion about him.” However, if the user enters this input string into a traditional search engine (e.g., Google, Bing, Cuil, and Yahoo!), the results that come back are highly irrelevant.

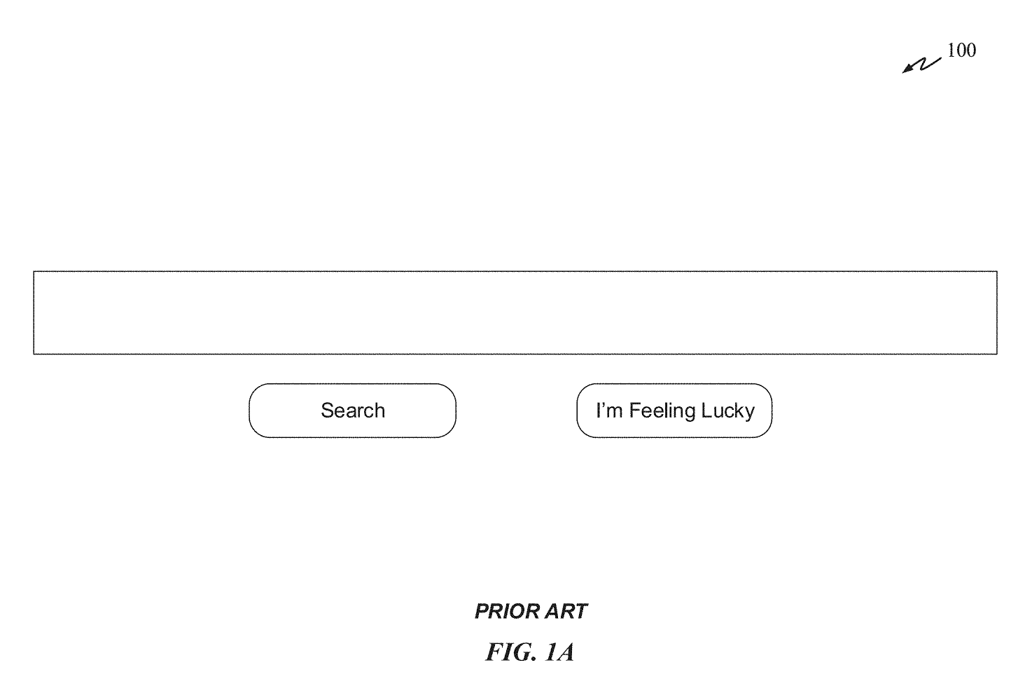

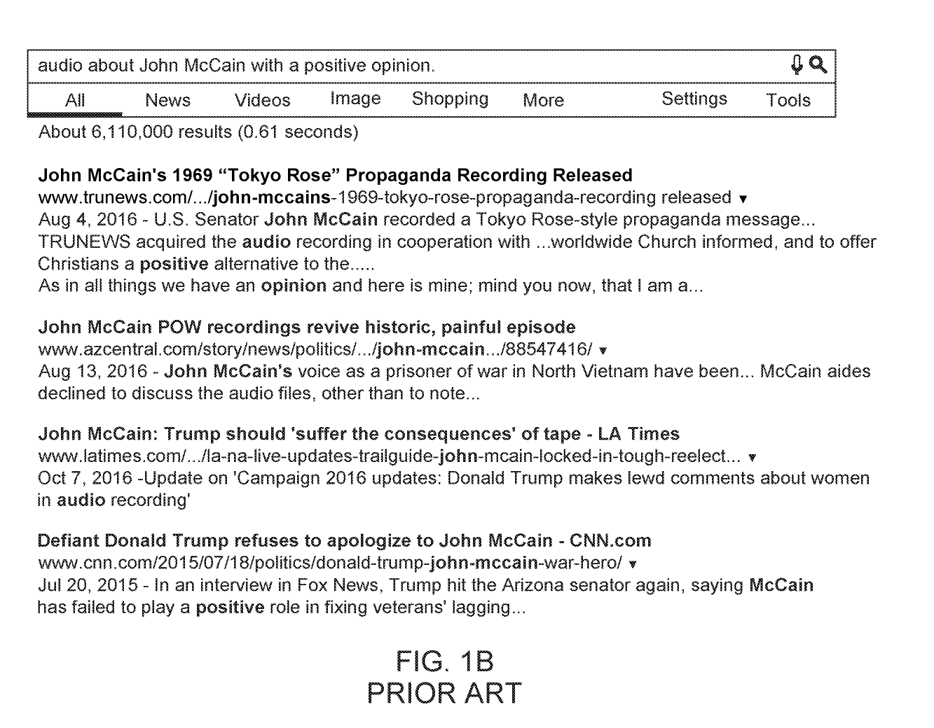

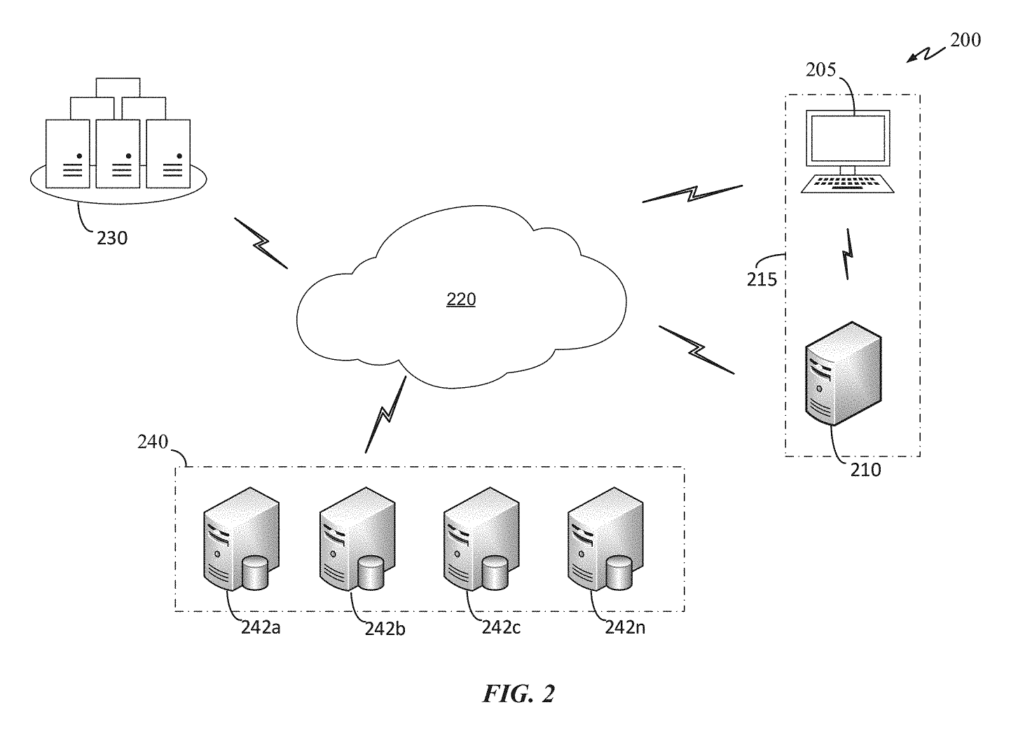

FIG. 1A illustrates a typical prior art search user interface 100 that includes input box 110 and search buttons 115A-B. User interface 100 is simple and straightforward. To perform a search, a user simply enters an alphanumeric string into input box 110 and selects either button 115A or 115B. Occasionally, search button 115A is shown as a magnifying glass on the right side of input box 110. In user interface 100, the user may direct the search engine to perform a search using only the alphanumeric text string such as “images of Snoopy playing tennis.” Here, the words “images of” are not part of the subject to be searched but rather they are instruction words for the engine. This assumes the engine is smart enough to figure out which words are instruction words and which words are subject(s) to be searched. In the above example, the input string is simple and most engines would not have an issue parsing the out the instruction words and words to be searched (search-subject words).

However, the input strings can get complicated when there several search subjects and type of searches involved. For example, given the input string “videos of Snoopy and Charlie Brown playing football while talking about teamwork and with Vivaldi Four Seasons playing in the background,” it is much harder for a traditional search engine to accurately and quickly parse out instruction words and search-subject words. When performing the above search using traditional search engines, the results are most likely irrelevant and not on point. Additionally, the traditional search engine would not be able to inform the user with a high level of confidence whether such a video exists.

Referring back to the input string “audio about John McCain with a positive opinion.” This input string is queried using today's most popular search engines. As shown in FIG. 1B, none of the top results is an audio about John McCain where a positive opinion or things are said about him. In this example, all of the results are completely irrelevant. Arguably, the search string could be written in a better way (though it would not have helped). However, this type of search would have been simple to create using the multivariate user interface disclosed herein and the results would have been highly relevant and accurate.

FIG. 2 illustrates an environment 200 in which the multivariate search user interface and the search engine selection process operate in accordance with some embodiments of the disclosure. Environment 200 may include a client device 205 and a server 210. Both of client device 205 and server 210 may be on the same local area network (LAN). In some embodiments, client device 205 and server 210 are located at a point of sale (POS) 215 such as a store, a supermarket, a stadium, a movie theatre, or a restaurant, etc. Alternatively, POS 215 may reside in a home, a business, or a corporate office. Client device 205 and server 210 are both communicatively coupled to network 220, which may be the Internet.

Environment 200 may also include remote server 230 and a plurality of search engines 242a through 242n. Remote server 230 may maintain a database of search engines that may include a collection 240 of search engines 242a-n. Remote server 230 itself may be a collection of servers and may include one or more search engines similar to collection 240. Search engines 242a-n may include a plurality of search engines such as but not limited to transcription engines, facial recognition engines, object recognition engines, voice recognition engines, sentiment analysis engines, audio recognition engines, etc.

In some embodiments, the multivariate search user interface disclosed herein is displayed at client device 205. The multivariate search user interface may be generated by instructions and codes from UI module (not shown), which may reside on server 210 or remote server 230. Alternatively, UI module may reside directly on client device 205. The multivariate search user interface is designed to provide the user with the ability to perform multi-dimensional search over multiple search engines. The ability to perform multi-dimensional search over multiple search engines is incredibly advantageous over prior art single engine search technique because it allows the user to perform complex searches that is not currently possible with search engine like Google, Bing, etc. For example, using the disclosed multivariate search user interface, the user may perform a search for all videos of President Obama during the last 5 years standing in front of the Whitehouse Rose Garden talking about Chancellor Angela Merkel. This type of search is not possible with current prior art searching UI.

In some embodiments, server 210 may include one or more specialized search engines similar to one or more of search engines 242a-242n. In this way, a specialized search may be conducted at POS 215 using server 210 that may be specially designed to serve POS 215. For example, POS 215 may be a retailer like Macy's and server 210 may contain specialized search engines for facial and object recognition in order to track customers purchasing habits and store shopping pattern. Server 210 may also work with one or more search engines in collection 240. Ultimately, the multivariate search system will be able to help Macy's management to answer question such as “how many times did Customer A purchase ties or shoes during the last 6 months.” In some embodiments, client device 205 may communicate with server 230 to perform the same search. However, a localized solution may be more desirable for certain customers where a lot of data are locally generated such as a retail or grocery store.

### Multivariate Search User Interface

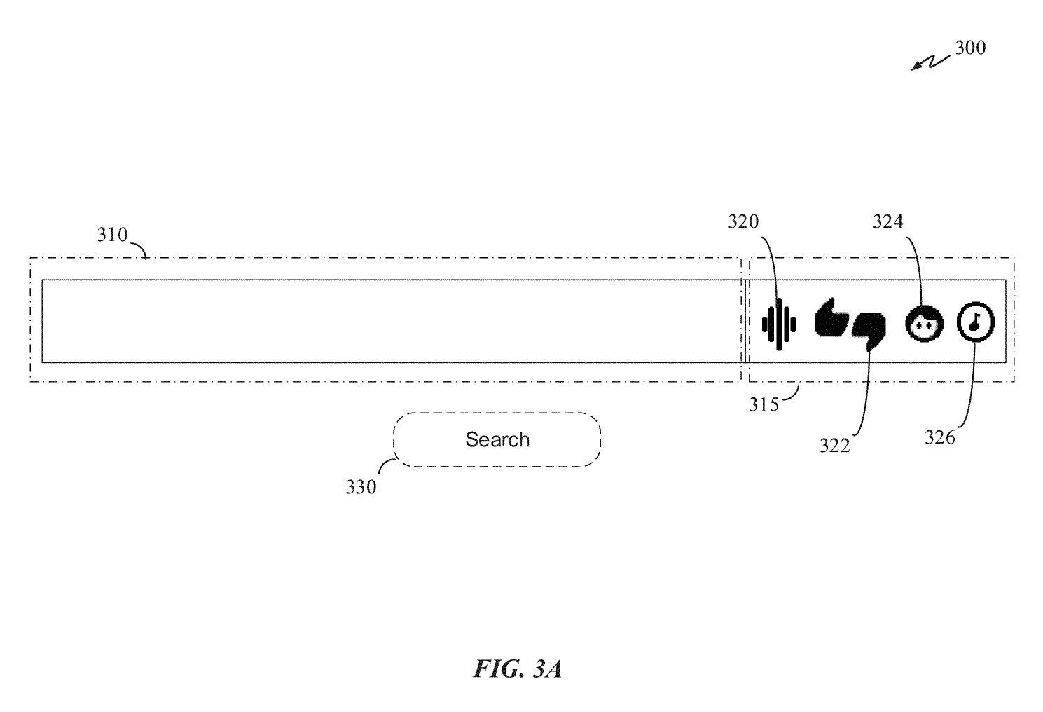

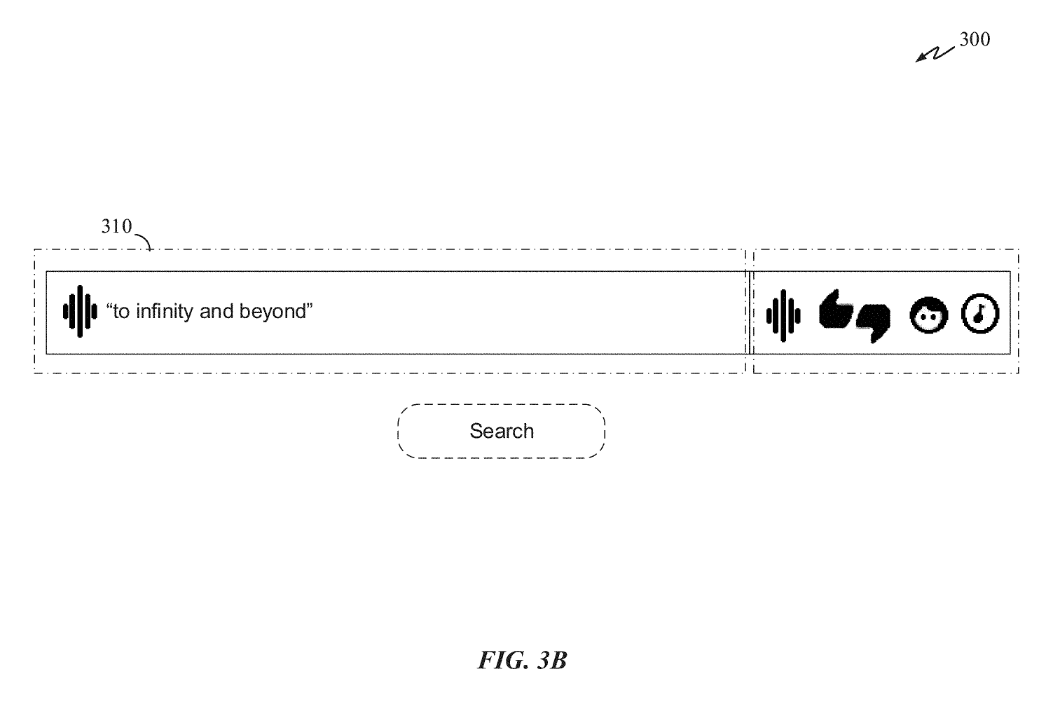

FIG. 3A illustrates a multivariate search user interface 300 in accordance with some embodiment of the disclosure. User interface 300 includes an input portion 310, an object display and selection portion 315, and optionally a search button 330. Search type selection portion 315 may include two or more search type objects or icons, each object indicates the type of search to be performed or the type of search engine to be used on an input string. As shown in FIG. 3, search type selection portion 315 includes a waveform icon 320, a thumbs icon 322, a face icon 324, and a music icon 326.

In some embodiments, waveform icon 320 represents a transcription search. This may include a search for an audio file, a video file, and/or a multimedia file—whether streamed, broadcasted, or stored in memory—containing a transcription that matches (or closely matches) with the query string entered by a user in input portion 310. Waveform icon 320 may also Accordingly, using user interface 300, to search for an audio or video having the phrase “to infinity and beyond,” the user may first input the string and then may select waveform 320 to assign or associate the search type to the input string. Alternatively, the order may be reversed. In that, the user may first select waveform 320 and then enter the input string. Once this completed, the string “to infinity and beyond” will appear together with waveform icon 320 as a single entity inside of input box 310. Alternatively, the string “to infinity and beyond” and waveform icon 320 may appear together as a single entity outside of input box 310.

In some embodiments, the input string and its associated search type selection icon (e.g., 320-326) may be shown with the same color or surrounded by the same border. In this way, the user will be able to visually see waveform icon 322 and “to infinity and beyond” as being associated with each other, see FIG. 3B.

Thumbs icon 322 may represent the sentiment assigned to a particular subject, person, topic, item, sentence, paragraph, article, audio clip, video clip, etc. Thumbs icon 322 allows a user to conduct a search based on sentiment. For example, the user may search for all things relating to a person that is positive (with a positive sentiment). This type of search is very difficult to do on a traditional search interface using a traditional search engine. More specifically, if a search is performed using traditional search engines (e.g., Google and Yahoo!) on an input string “John McCain positive,” the results would most likely be irrelevant. However, this type of search may be done with ease using interface 300 by simply entering in the keywords “John McCain” and then “positive” and selecting thumbs icon 322. It should be noted that the input order may be reversed. For example, thumbs icon 322 may be selected before entering the word “positive.”

In the above example, thumbs icon 322 together with the word “positive” serves as an indication to both the user and the backend search engine that a sentiment search is to be performed and that only positive sentiments are to be searched. This advantageously create an accurate and concise search parameter that will focus the search engine and thereby will lead to a much more accurate results over the prior art. In some embodiments, negative and neutral sentiments may also be used with thumbs icon 322. It should be noted that emotion sentiments may also be used such as fear, horror, anxious, sad, happy, disappointment, proud, jubilation, excitement, etc.

Face icon 324 may represent a facial recognition search. In one example, the user may select face icon 324 and type in a name such as “John McCain.” This will instruct the search engine to find pictures and videos with John McCain in them. This simplifies the search string and eliminates the need for words such as “images and videos of.”

In some embodiments, musical note icon 326 represents a voice recognition. Accordingly, a user may select icon 326 and assigned to the keyword “John McCain.” This will cause the search engine to find any multimedia (e.g., audio clips, video, video games, etc.) where the voice of John McCain is present. The efficiency of user interface 300 is more evidence as the query gets more complicated. For example, it would be very difficult for a traditional search engine and user interface to find “video of Obama while John McCain is talking about the debt ceiling.” One may try to enter the above string as a search input on traditional search engine and UI, but the search results are most likely irrelevant. However, using user interface 300, one can distill this complicate search hypothetical into a concise search profile: [symbol] President Obama [symbol] John McCain [symbol] Debt ceiling.

The above search input concisely indicates the type of search to be performed and on what keywords. This reduces potential confusion on the backend search engine and greatly increases the speed and accuracy of the multivariate search.

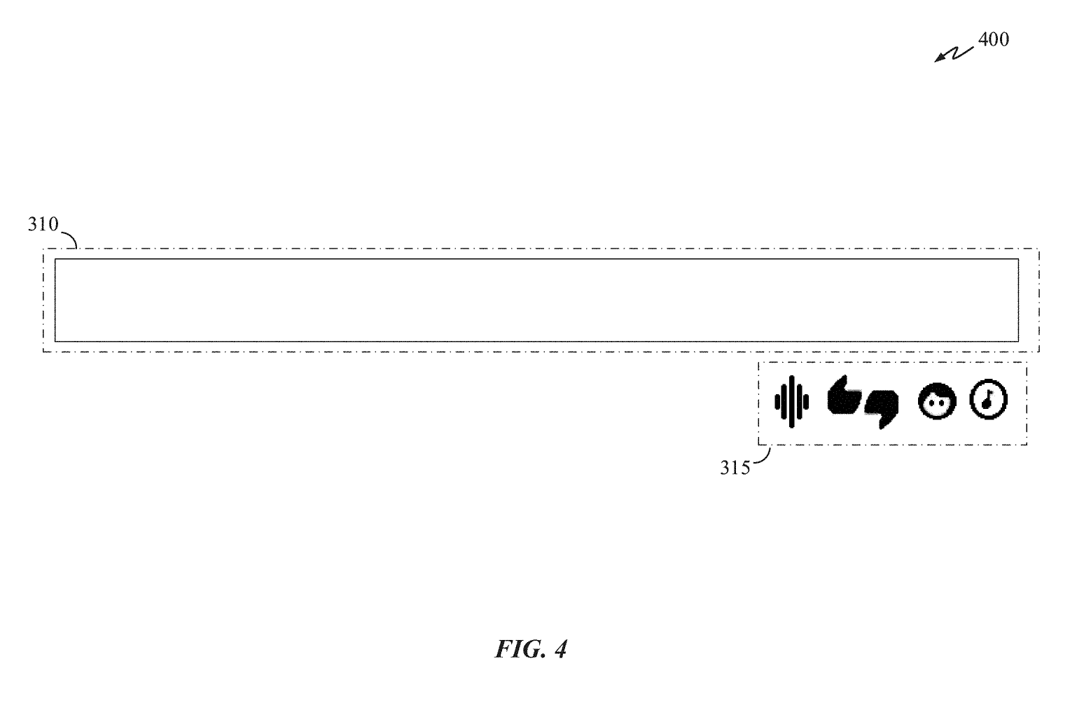

FIG. 4 illustrates a multivariate search user interface 400 in accordance with some embodiments of the present disclosure. User interface 400 is similar to user interface 300 as it also includes input portion 310 and search type selection portion 315. However, in user interface 400, the search type selection portion 315 is positioned outside of input portion 310. In user interface 300, portion 315 is positioned on the same horizontal plane as input portion 310. In user interface 400, search type selection portion 315 is located away from the horizontal plane of input portion 310. In some embodiments, search type selection portion 315 is located below input portion 310 when user interface 400 is viewed in a normal perspective where any text inside of input portion 310 would appear in their normal reading (right side up) perspective. Alternatively, search type selection portion may be located above input portion 310.

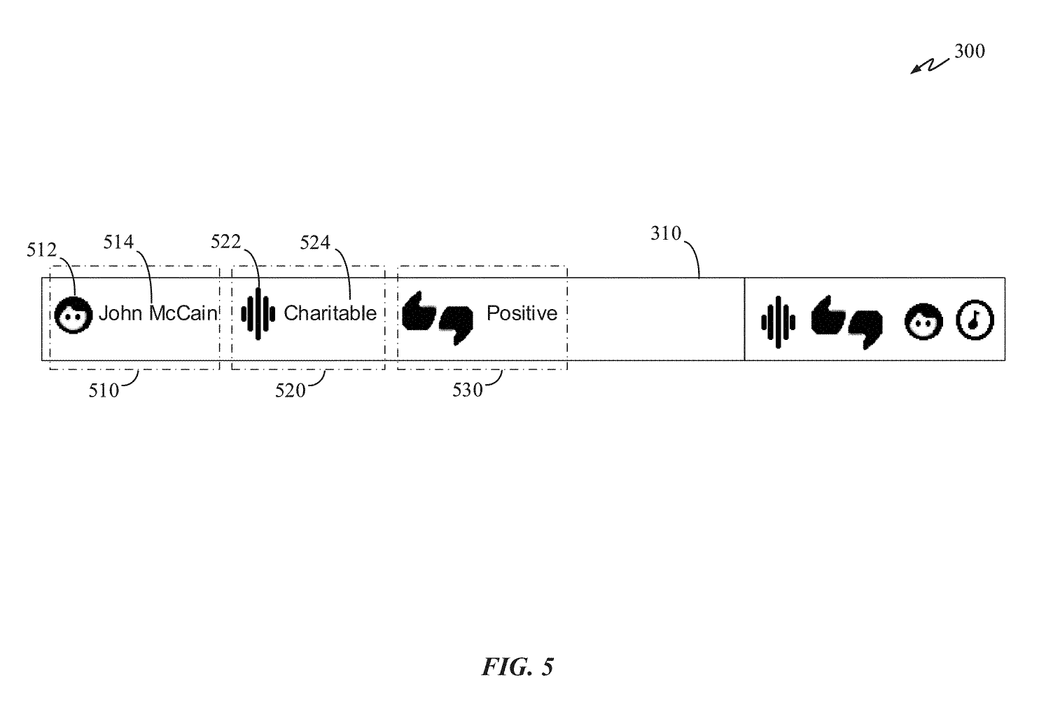

FIG. 5 illustrates multivariate search user interface 300 displaying search parameter groups consisting of query input and search type icon in accordance with some embodiments. As shown in FIG. 5, user interface 300 includes search parameter groups 510, 520, and 530. Search group 510 includes face icon 512 and text input 514. In some embodiments, icon 512 and text input 514 are shown as a group or as a single entity. In this way, text input 514 is associated with icon 512, which indicates that a facial recognition search is to be performed for media where John McCain is present. Group 510 may be shown using the same or similar color. In some embodiment, items each groups may be shown in close spatial proximity with each other to establish association by proximity. Similarly, group 520 includes waveform icon 522 and text input 524 with the keyword “Charitable”. This indicates to the user and the backend search engine that a transcription search is to be performed for the word charitable. Lastly, group 530 shows a thumbs icon associated with the word positive. This indicates that a search for a media having John McCain in the media where the word “Charitable” is mentioned and that the sentiment for the media (e.g., article, news clip, audio clip, video, etc.) is positive.

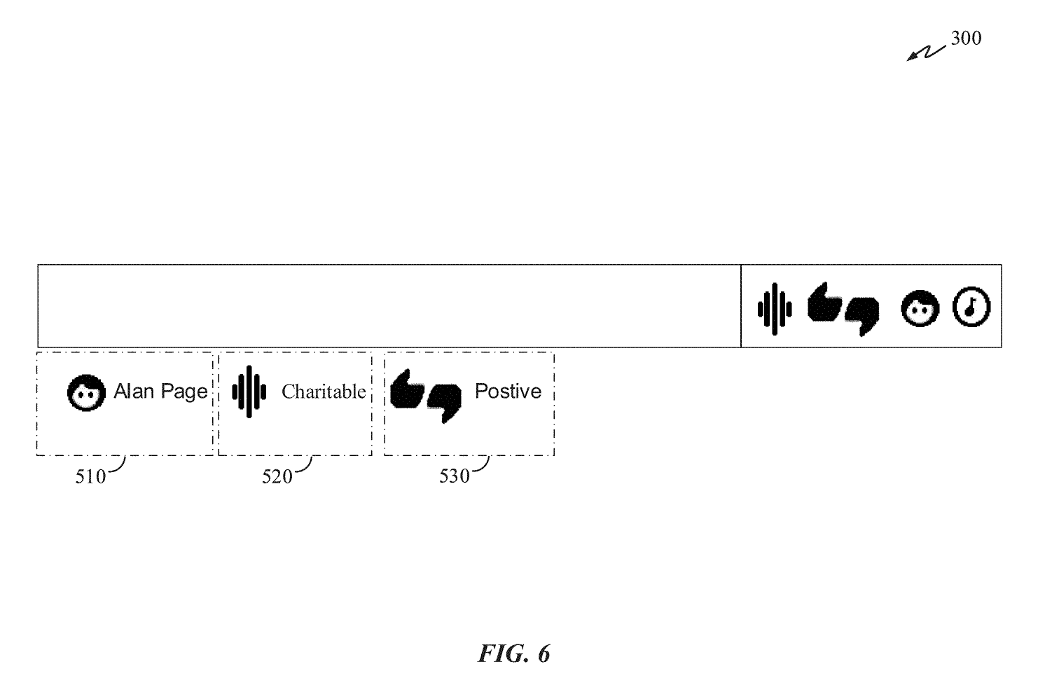

As shown in FIG. 5, search parameter groups 510, 520, and 530 are displayed within input portion 310. In some embodiment, one or more of the search parameter groups are displayed outside of input portion 310. FIG. 6 illustrates user interface 300 but with displays the input keyword (query text) along with it associated search type option outside of input box 310.

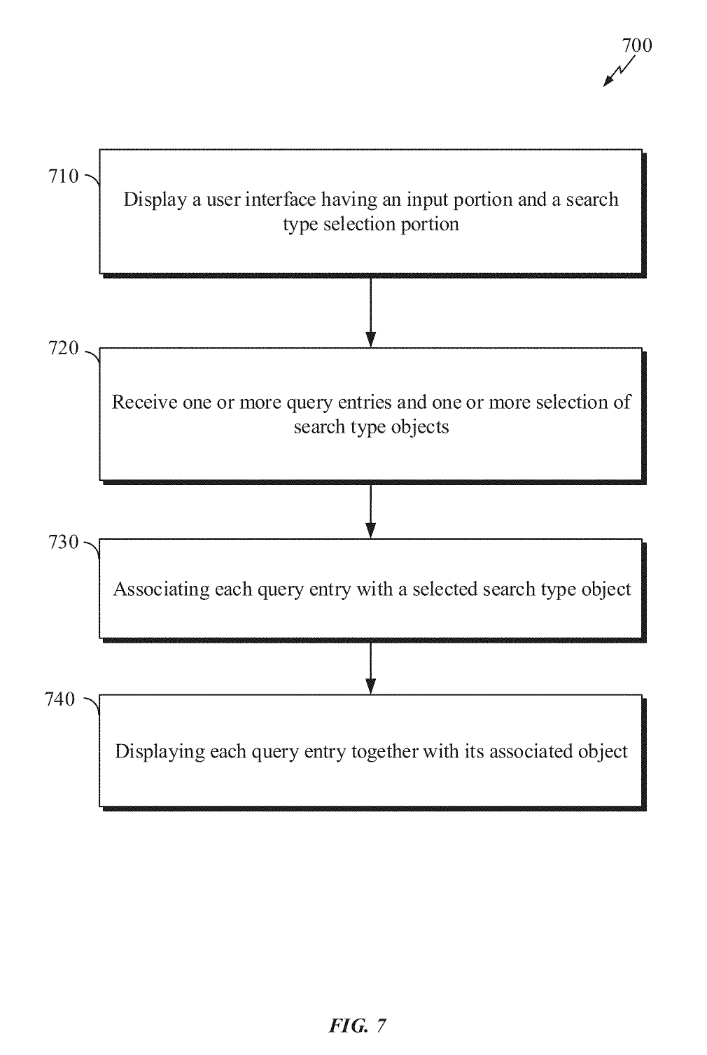

FIG. 7 is a flow chart illustrating a process 700 for generating and displaying a multivariate user interface in accordance with embodiments of the present disclosure. Process 700 starts at 710 where a user interface (e.g., user interface 300) having an input portion (e.g., input portion 310) and a search type selection portion (e.g., selection portion 315) is generated. The input portion may be a text box to receive alphanumeric input from the user. The input portion may include a microphone icon that enables the user to input the query string using a microphone.

The search type selection portion may include one or more icons, text, images, or a combination thereof. Each of the icons, text, or images is associated to a search type to be performed on the search/query string entered at the input portion. In one aspect, a waveform icon may correspond to a transcription search, which means a transcription search is to be performed when the waveform icon is selected. A face or person icon may correspond to a facial recognition search. A musical note icon may correspond to voice recognition or audio fingerprinting search. An image icon may correspond to a search for an item or geographic location search such as Paris, France or Eiffel Tower.

The search type selection portion may also include an object search icon that indicates an object search is to be performed on the search string. In other words, an object search will be performed for the object/item in the search string. Once a search string is entered in the input portion, the user may assign a search type to the inputted search string by selecting one of the displayed icons. Alternatively, the search type may be selected before the user can enter its associated search string. Once the user inputs the search string and selects a corresponding search type icon, the search string and its corresponding search type icon are received (at 720) by the computer system or the UI host computer.

In an example, referring again to FIG. 5, a user may enter the text “John McCain” (string 514) in input box 310 and then may subsequently select face icon 512. Upon the selection of face icon 512, user interface 500 may associate string 514 with face icon 512 and display them as a string-icon pair or search parameter group 510 in input box 310, which is now ready for the next input. Search parameter group 510 serves two main functions. First, it informs the user that string 514 “John McCain” is grouped or associated (730) with face icon 512, thereby confirming his/her input. Secondly, search parameter group 510 serves as instructions to the search engine, which include two portions. A first portion is the input string, which in this case is “John McCain.” The second portion is the search type, which in this case is face icon 512. As previously described, face icon 512 means a facial recognition search is to be performed on the input/search string. These two portions make up the elementary data architecture of a search parameter. In this way, search parameter 510 can concisely inform a search engine how and what to search for with its unique data structure.

Again, the user may enter the keyword “Charitable” and then select waveform icon 522 to complete the association of the transcription search type with the keyword “Charitable.” This waveform icon 522 and Charitable pair may then be displayed in input box 310 next to the previous search string-icon pair or search parameter group. In another example, the user may enter the keyword “football” and then select an object-recognition search icon. This means the search will be focused on an image or video search with a football in the picture or video and excludes all audio, documents, and transcription of “football.”

In another example, to search for images or videos of President Obama in Paris and with the Eiffel Tower in the background, the user may create the following search string and search type pairings: face icon: “President Obama”; image icon: “Eiffel Tower.” This may be done by first entering in the keywords “President Obama” then selecting the face icon. This action informs the search server to conduct a facial recognition search President Obama. Still further, in another example, to search for images or videos of President Obama in Paris with the Eiffel Tower in the background and the President talking about the economy, the user may create the following search string and search type parings: face icon: “President Obama”; image icon: “Eiffel Tower”; waveform icon: “economy”; and musical note icon: “Obama”.

At 740, each of the input string (search string entry or input string) and its associated search type icon or object is displayed on the user interface. In some embodiments, each of the input string and its associated search type icon is displayed as a single unit or displayed as a pair. In this way, the user can immediately tell that they are associated with each other. When looking at the face icon being paired with “President Obama,” the user can visually tell that a facial recognition search is to be performed for media with President Obama. This input string or search string and search type pairing may be done using visual cues such as spatial proximity, color, pattern, or a combination thereof.

In some embodiments, the above described user interface may be generated on a client computer using an API that is configured to facilitate the host webpage for interfacing with a backend multivariate search engine. In some embodiments, the source code for generating the user interface may comprise a set of application program interfaces (APIs)) and that provides an interface for a host webpage to communicate the backend multivariate search engine. For example, the set of APIs may be used to create an instantiation of the user interface on the host webpage of the client device. The APIs may provide a set of UI parameters that a host of the hosting webpage can choose from and may be a part of the UI to be used by the users. Alternatively, the UI generating source code may reside on the server, which then interacts with API calls from the host webpage to generate the above described UI.

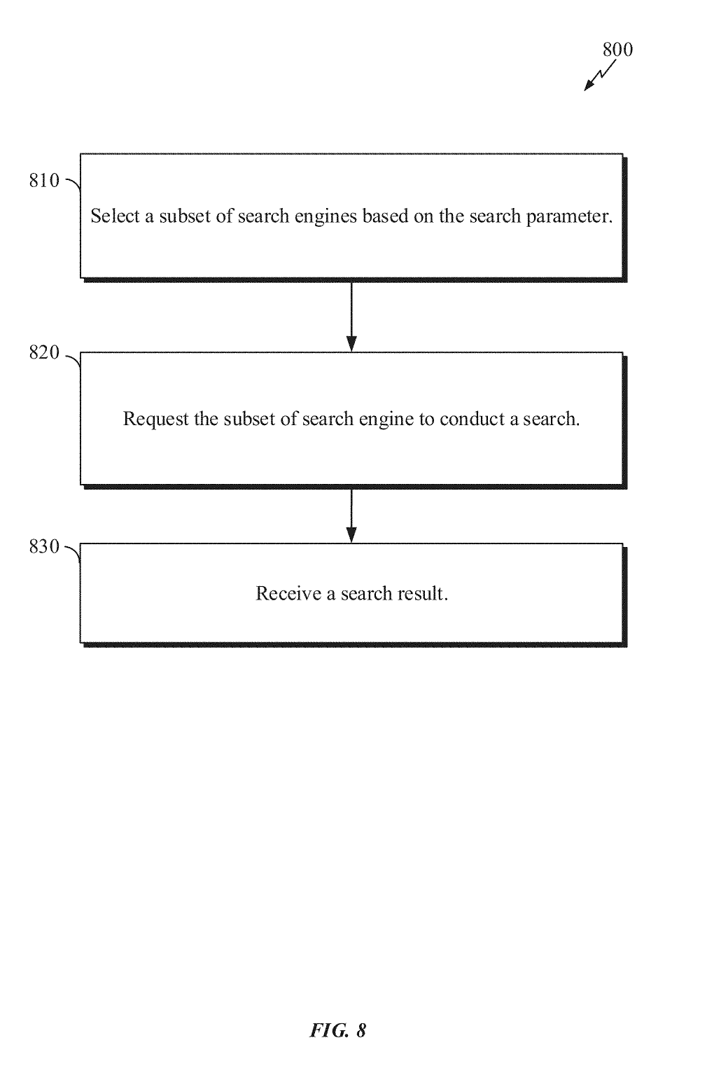

FIG. 8 is a flow chart illustrating a process 800 for performing a search using the input received from a multivariate UI in accordance with some embodiment of the disclosure. Process 800 starts at 810 where a subset of search engines, from a database of search engines, is selected based on a search parameter received at process 700. In some embodiments, the subset of search engines may be selected based on a portion of search parameter group 510 received at process 700, which may include a search/input string (input string) and a search type indicator. In some embodiments, the subset of search engines is selected based on the search type indicator of search parameter group 510. For example, the search type indicator may be face icon 512, which represents a facial recognition search. In this example, process 800 (at 810) selects a subset of search engines that can perform facial recognition on an image, a video, or any type of media where a facial recognition may be performed. Accordingly, from a database of search engines, process 800 (at 810) may select one or more of a facial recognition engines such as PicTriev, Google Image, facesearch, TinEye, etc. For example, PicTriev and TinEye may be selected as the subset of search engines at 810. This eliminates the rest of the unselected facial recognition engines along with numerous of other search engines that may specialize in other types of searches such as voice recognition, object recognition, transcription, sentiment analysis, etc.

In some embodiments, process 800 is part of a search conductor module that selects one or more search engines to perform a search based on the inputted search parameter, which may include a search string and a search type indicator. Process 800 maintains a database of search engines and classifies each search engine into one or more categories which indicate the specialty of the search engine. The categories of search engine may include, but not limited to, transcription, facial recognition, object/item recognition, voice recognition, audio recognition (other than voice, e.g., music), etc. Rather than using a single search engine, process 800 leverages all of the search engines in the database by taking advantage of each search engine's uniqueness and specialty. For example, certain transcription engine works better with audio data having a certain bit rate or compression format. While another transcription engine works better with audio data in stereo with left and right channel information. Each of the search engine's uniqueness and specialty are stored in a historical database, which can be queried to match with the current search parameter to determine which database(s) would be best to conduct the current search.

In some embodiments, at 810, prior to selecting a subset of search engines, process 800 may compare one or more data attributes of the search parameter with attributes of databases in the historical database. For example, the search/input string of the search parameter may be a medical related question. Thus, one of the data attributes for the search parameter is medical. Process 800 then searches the historical database to determine which database is best suited for a medical related search. Using historical data and attributes preassigned to existing databases, process 800 may match the medical attribute of the search parameter with one or more databases that have previously been flagged or assigned to the medical field. Process 800 may use the historical database in combination with search type information of the search parameter to select the subset of search engines. In other words, process 800 may first narrows down the candidate databases using the search type information and then uses the historical database to further narrows the list of candidate databases. Stated differently, process 800 may first select a first group of database that can perform image recognition based the search type being a face icon (which indicate a facial recognition search), for example. Then using the data attributes of the search string, process 800 can select one or more search engines that are known (based on historical performance) to be good at searching for medical images.

In some embodiments, if a match or best match is not found in the historical database, process 800 may match the data attribute of the search parameter to a training set, which is a set of data with known attributes used to test against a plurality of search engines. Once a search engine is found to work best with the training set, then search engine is associated with that training set. There are numerous training sets, each with its unique set of data attributes such as one or more of attributes relating to medical, entertainment, legal, comedy, science, mathematics, literature, history, music, advertisement, movies, agriculture, business, etc. After running each training set against multiple search engines, each training set is matched with one or more search engines that have been found to work best for its attributes. In some embodiments, at 810, process 800 examines the data attributes of the search parameter and matches the attributes with one of the training sets data attributes. Next, a subset of search engines is selected based on which search engines were previously associated to the training sets that match with data attribute of the search parameter.

In some embodiments, data attributes of the search parameter and the training set may include but not limited to type of field, technology area, year created, audio quality, video quality, location, demographic, psychographic, genre, etc. For example, given the search input “find all videos of Obama talking about green energy in the last 5 years at the Whitehouse,” the data attributes may include: politics; years created 2012-2017, location: Washington D.C. and Whitehouse.

At 820, the selected subset of search engines is requested to conduct a search using the search string portion of search parameter group 510, for example. In some embodiments, the selected subset of search engines includes only 1 search engine. At 830, the search results are received, which may be displayed.

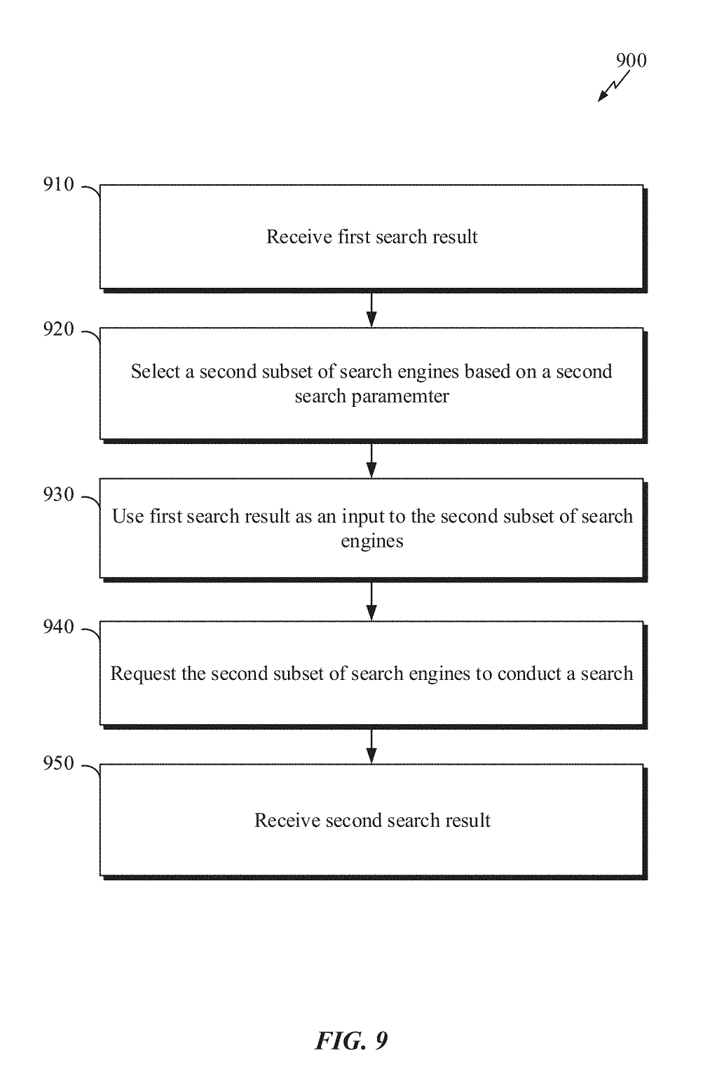

FIG. 9 is a flow chart illustrating a process 900 for chain cognition, which is the process of chaining one search to another search in accordance to some embodiments of the disclosure. Chain cognition is a concept not used by prior art search engines. On a high level, chain cognition is multivariate (multi-dimensional) search done on a search profile having two or more search parameters. For example, given the search profile: [symbol] President Obama [symbol] John McCain [symbol] Debt ceiling, this search profile consists of three search parameter groups: face icon “President Obama”; voice recognition icon “John McCain”; and transcription icon “Debt ceiling.” This search profile requires at a minimum of 2 searches being chained together. In some embodiments, a first search is conducted for all multimedia with John McCain's voice talking about the debt ceiling. Once that search is completed, the results are received and stored (at 910). At 920, a second subset of search engines is selected based on the second search parameter. In this case, it may be face icon, which means that the second search will use a facial recognition engines. Accordingly, at 920, only facial recognition engines are selected as the second subset of search engines. At 930, the results received at 910 is used as input for the second subset of search engines to help narrow and focus the search. At 940, the second subset of search engine is requested to find videos with President Obama present while John McCain is talking about the debt ceiling. Using the results at 910, the second subset of search engines will be able to quickly focus the search and ignore all other data. In the above example, it should be noted that the search order in the chain may be reversed by performing a search for all videos of President Obama first, then feeding that results into a voice recognition engine to look for John McCain voice and the debt ceiling transcription.

Additionally, in the above example, only 2 chain searches were conducted. However, in practice, many chain searches can be chained together to form a long (e.g., over 4 multivariate search chain) search profile.

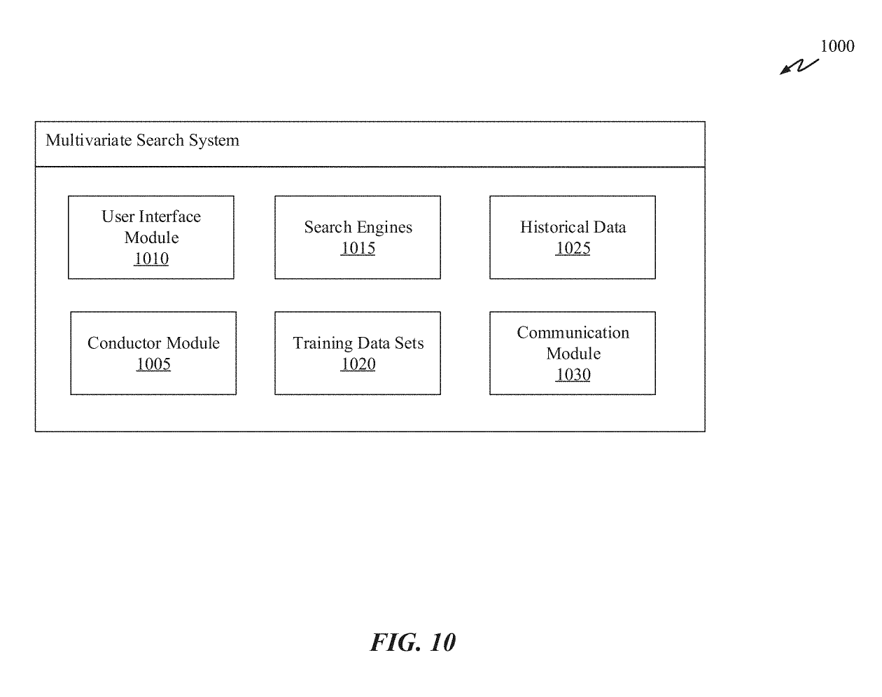

FIG. 10 illustrates a system diagram of a multivariate search system 1000 in accordance with embodiments of the disclosure. System 1000 may include a search conductor module 1005, user interface module 1010, a collection of search engines 1015, training data sets 1025, historical databases 1025, and communication module 1030. System 1000 may reside on a single server or may be distributedly located. For example, one or more components (e.g., 1005, 1010, 1015, etc.) of system 1000 may be distributedly located at various locations throughout a network. User interface module 1010 may reside either on the client side or the server side. Similarly, conductor module 1005 may also reside either on the client side or server side. Each component or module of system 1000 may communicate with each other and with external entities via communication module 1030. Each component or module of system 1000 may include its own sub-communication module to further facilitate with intra and/or inter-system communication.

User interface module 1010 may contain codes and instructions which when executed by a processor will cause the processor to generate user interfaces 300 and 400 (as shown in FIG. 3 through FIG. 6.). User interface module 1010 may also be configured to perform process 700 as described in FIG. 7.

Search conductor module 1005 may be configured to perform process 800 and/or process 900 as described in FIGS. 8-9. In some embodiments, search conductor module 1005 main task is to select the best search engine from the collection of search engines 1015 to perform the search based on one or more of: the inputted search parameter, historical data (stored on historical database 1025), and training data set 1020.

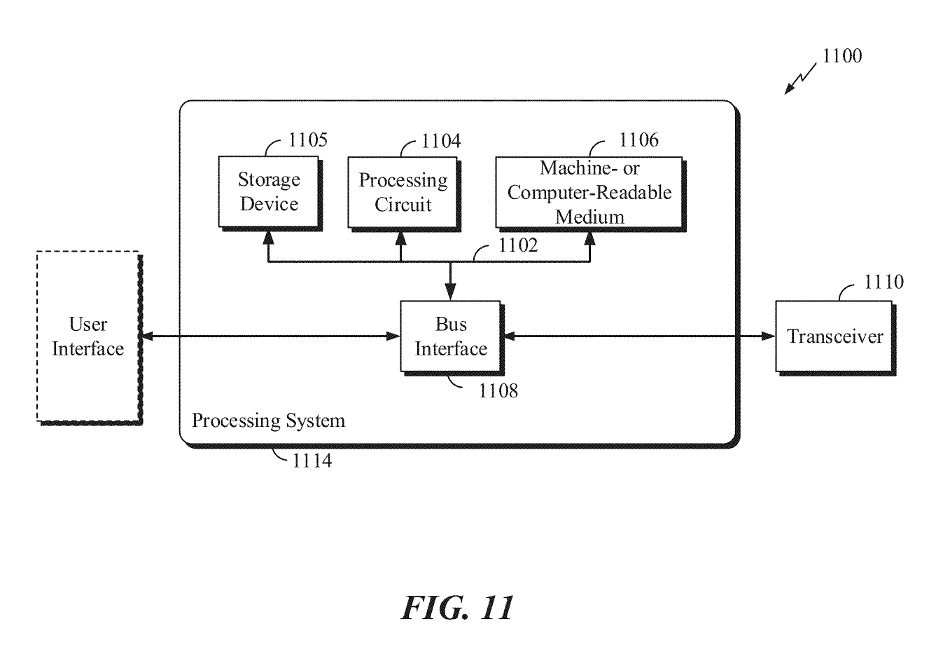

FIG. 11 illustrates an overall system or apparatus 1100 in which processes 700, 800, and 900 may be implemented. In accordance with various aspects of the disclosure, an element, or any portion of an element, or any combination of elements may be implemented with a processing system 1114 that includes one or more processing circuits 1104. Processing circuits 1104 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. That is, the processing circuit 1104 may be used to implement any one or more of the processes described above and illustrated in FIGS. 7, 8, and 9.

In the example of FIG. 11, the processing system 1114 may be implemented with a bus architecture, represented generally by the bus 1102. The bus 1102 may include any number of interconnecting buses and bridges depending on the specific application of the processing system 1114 and the overall design constraints. The bus 1102 links various circuits including one or more processing circuits (represented generally by the processing circuit 1104), the storage device 1105, and a machine-readable, processor-readable, processing circuit-readable or computer-readable media (represented generally by a non-transitory machine-readable medium 1108.) The bus 1102 may also link various other circuits such as timing sources, peripherals, voltage regulators, and power management circuits, which are well known in the art, and therefore, will not be described any further. The bus interface 1108 provides an interface between bus 1102 and a transceiver 1110. The transceiver 1110 provides a means for communicating with various other apparatus over a transmission medium. Depending upon the nature of the apparatus, a user interface 1112 (e.g., keypad, display, speaker, microphone, touchscreen, motion sensor) may also be provided.

The processing circuit 1104 is responsible for managing the bus 1102 and for general processing, including the execution of software stored on the machine-readable medium 1108. The software, when executed by processing circuit 1104, causes processing system 1114 to perform the various functions described herein for any particular apparatus. Machine-readable medium 1108 may also be used for storing data that is manipulated by processing circuit 1104 when executing software.

One or more processing circuits 1104 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 1108. The machine-readable medium 1108 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 1108 may reside in the processing system 1114, external to the processing system 1114, or distributed across multiple entities including the processing system 1114. The machine-readable medium 1108 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1. A method for providing a user interface for performing a multivariate search, the method comprising:
displaying, by a computing device, the user interface having an input portion and a search type selection portion, the search type selection portion having two or more search type objects, each object corresponds to a different type of search to be performed;
receiving, by the computing device, a first input string in the input portion and a first selection of one of the two or more search type objects;
associating a first search type on the first input string based on the first selection of one of the search type objects;
displaying, by the computing device, the first search type and the first input string on the user interface;
receiving, by the computing device, a second input string in the input portion and a second selection of one of the two or more search type objects, wherein the first and second selections are of different objects;
associating a second search type on the second input string based on the first selection of one of the search type objects; and
displaying, by the computing device, the second search type and the second input string on the user interface.

2. The method of claim 1, wherein the objects are icons, each icon representing a different type of search to be performed on the first input string.

3. The method of claim 1, wherein the input portion is an input textbox.

4. The method of claim 1, wherein the search type selection portion is adjacent to the input portion.

5. The method of claim 1, wherein the search type selection portion is located within the input portion.

6. The method of claim 1, wherein the two or more search type objects are selected from the group consisting of a first icon representing a text based search, a second icon representing a facial recognition search, a third icon representing an audio search, and a fourth icon representing a sentiment search.

7. The method of claim 1, wherein each of the input string and search type is displayed in the input portion.

8. The method of claim 1, wherein each of the input string and search type is displayed outside of the input portion.

9. The method of claim 1, wherein the first search type and the first input string are displayed as a first combined item on the user interface.

10. The method of claim 9, wherein the second search type and the second input string are displayed as a second combined item on the user interface after the first combined item.

11. (canceled)

12. The method of claim 1, further comprising:
receiving, at the computing device, a request to perform a query using the received first and second input strings; and
sending the first and second input strings and the first and second search types to a remote server.

13. A non-transitory processor-readable medium having one or more instructions operational on a computing device, which when executed by a processor causes the processor to:
display, by a computing device, a user interface having an input portion and a search type selection portion, the search type selection portion having two or more search type objects, each object corresponds to a different type of search to be performed;
receive, by the computing device, a first input string in the input portion and a first selection of one of the two or more search type objects;
assign a first search type on the first input string based on the first selection of one of the search type objects;
display, by the computing device, the first search type and the first input string on the user interface;
receive, by the computing device, a second input string in the input portion and a second selection of one of the two or more search type objects, wherein the first and second selections are of different objects;
assign a second search type on the second input string based on the first selection of one of the search type objects; and
display, by the computing device, the second search type and the second input string on the user interface.

14. The non-transitory processor-readable medium of claim 13, wherein the objects are icons, each icon representing a different type of search to be performed on an input string.

15. The non-transitory processor-readable medium of claim 13, wherein the search type selection portion is adjacent to the input portion.

16. The non-transitory processor-readable medium of claim 13, wherein the search type selection portion is located within the input portion.

17. The non-transitory processor-readable medium of claim 13, wherein the two or more search type objects are selected from the group consisting of a first icon representing a text based search, a second icon representing a facial recognition search, a third icon representing an audio search, and a fourth icon representing a sentiment search.

18. (canceled)

19. The non-transitory processor-readable medium of claim 13, wherein each of the input string and search type is displayed outside of the input portion.

20. The non-transitory processor-readable medium of claim 13, wherein the first search type and the first input string are displayed as a first combined item on the user interface.

21. (canceled)

22. The non-transitory processor-readable medium of claim 13, wherein the at least two search type objects comprise a first icon representing a text based search, a second icon representing a facial recognition search, a third icon representing an audio search, and a fourth icon representing a sentiment search.

23. A method for providing a user interface and for performing a multivariate search, the method comprising:
displaying, by a computing device, the user interface having an input portion and a search type selection portion, the search type selection portion having two or more search type objects, each object corresponds to a different type of search to be performed;
receiving, by the computing device, a first input string in the input portion and a first selection of one of the two or more search type objects;
displaying, by the computing device, the first search type and the first input string on the user interface;
selecting a subset of search engines from the database of search engines based on the first selection of the search type object;
requesting the selected subset of search engines to conduct a search; and
receiving search results from the selected subset of search engines.
